(19) United States
(12) Patent Application Publication
(10) Pub. No.: US 2017/0091471 A1
(43) Pub. Date: Mar. 30, 2017

(54) Clustering A Repository Based On User Behavioral Data

(71) Applicant: QUALCOMM Incorporated, San Diego, CA (US)

(72) Inventors: Shih-Chieh Su, San Diego, CA (US); Jean-Laurent Ngoc Huynh, San Diego, CA (US); Joseph Mark Vaughn, San Diego, CA (US)

(21) Appl. No.: 14/866,687

(22) Filed: Sep. 25, 2015

(51) Int. Cl. G06F 21/62; G06F 17/30

(52) U.S. Cl. CPC G06F 21/6218; G06F 17/30598; G06F 17/30126

(57) ABSTRACT

This document describes techniques by which users and files of a repository are accurately correlated into clusters. These clusters often indicate particular projects, as users are correlated with the projects on which they collaborate. By clustering these users and files, the techniques enable access control that permits both collaboration and excellent security. The techniques also enable determination of data loss, security vulnerabilities, job functions, project scope, and multiple-repository correlations.

### BACKGROUND

Field of the Disclosure

This disclosure relates generally to file repositories, and, more specifically, to clustering files and projects using behavioral data.

Description of Related Art

Existing repositories fail to accurately associate files with their projects, such as work-related projects on which various employees collaborate. Without this accurate association, access to the files cannot be adequately controlled, creating serious security weaknesses or making collaboration difficult. Thus, access control, which limits a particular set of files to a particular set of users, is conventionally either set too stringently, making collaboration difficult, or set too loosely, permitting security weaknesses.

These problems have not been solved through automated technology or for large numbers of files. This is because files accessed for a project often span many different folders and areas in a repository, making accurate associate difficult. Because of this poor association between a project and its files, access controls are often mismatched, resulting in poor security, poor collaboration, or a substantial waste in personnel time.

### SUMMARY

In an example aspect, a method is disclosed. The method receives access indications for multiple users, each of the access indications indicating a resource and a user of the multiple users. With these access indications, the method correlates the access indications and the multiple users to cluster together subsets of the multiple users with subsets of the resources indicated in the access indications.

In an example aspect, an electronic device is disclosed. This electronic device includes computer-readable media and computer processors. The media includes user behavioral data indicating user access of files of a repository by multiple users and a cluster module. The cluster module correlates the user access of files of the repository by the multiple users into clusters, the clusters clustering subsets of the multiple users with subsets of the files indicated in the user behavioral data.

In an example aspect, computer-readable storage media having executable instructions is disclosed. These instructions receive access indications for users of a file repository. The instructions normalize numbers of files or file locations to numbers of the users through use of file proxies. The file proxies and the users are correlated to cluster together subsets of the users with subsets of the file proxies. These clusters are then used to generate a human-readable cluster diagram.

In an example aspect, a system is disclosed having computer processors and computer-readable media. The media includes user behavioral data indicating user access of files of a repository by multiple users and a means for correlating the user access of files of the repository by the multiple users into clusters. These clusters clustering subsets of the multiple users with subsets of the files indicated in the user behavioral data.

### BRIEF DESCRIPTION OF DRAWINGS

FIG. 1 illustrates an example input diagram showing user access of files in a repository and a clustering of that input, resulting in an illustrated cluster diagram.

FIG. 2 illustrates four examples of the access indications of the input diagram of FIG. 1.

FIG. 3 illustrates clusters of the cluster diagram of FIG. 1 in detail.

FIG. 4 illustrates an example method for clustering a repository based on user behavioral data.

FIG. 5 illustrates example clusters of two different repositories and total clusters of those different repositories.

FIG. 6 illustrates an example method having alternative or additional operations of the techniques.

FIG. 7 illustrates two example cluster diagrams showing use of clusters, here to determine files in a cluster used by users of multiple clusters and a security vulnerability.

FIG. 8 illustrates two example cluster diagrams showing use of clusters, here to determine job functions and security breaches.

FIG. 9 illustrates an example electronic device in which techniques for clustering a repository based on user behavioral data may be implemented.

### DETAILED DESCRIPTION

### Overview

As noted above, conventional access control is limited by inaccurate association between projects and resources. This document describes techniques by which users and resources, such as files of a repository, are accurately correlated into clusters. These clusters often indicate particular projects, as users are correlated with the projects on which they collaborate. Not only does this permit access control that enables both collaboration and excellent security, this clustering also enables determination of data loss, security vulnerabilities, job functions, project scope, and multiple-repository correlations.

In more detail, these techniques cluster users and resources by analyzing access logs for those resources. These resources can include anything to which access control or information about usage is desired. Resources can include files, machines, and devices, such as word processing documents and schematics, milling and fabrication machines, and computing and printing devices. In some cases these resources are within a repository or some other overarching structure or system. Thus, access logs for files in a file repository indicate the files and folders accessed and the users performing that access, as would access logs for users that have printed to, or viewed images scanned with, a printer. In various examples below, the examples given concern files in a file repository. This is for ease of discussion, as other types of resources can clustered with users as well.

By way of one simple example, assume that a small organization has 18 employees and a single repository. The techniques, by clustering files accessed with users accessing them, clusters employees into two clusters, one having four employees and the other having 12 employees. Assume also that the two remaining employees access files in both clusters. Through even this simple clustering, access to one project can be limited to the four correlated employees, and likewise the second project to the other 12 employees. Further, based on two employees accessing files from both clusters, the techniques may determine that one employee is likely a manager of both projects, and that another employee is likely a security breach.

This is but one simple example of ways in which techniques that cluster a repository based on user behavioral data can be performed. Other examples are provided below. This document now turns to an example of files accessed by users and clustering of those files and users, which, as noted, is but one example of types of resources that can be clustered using the techniques. It is followed by example methods, after which an example system is described.

### Example Repository Access Indications and Clustering

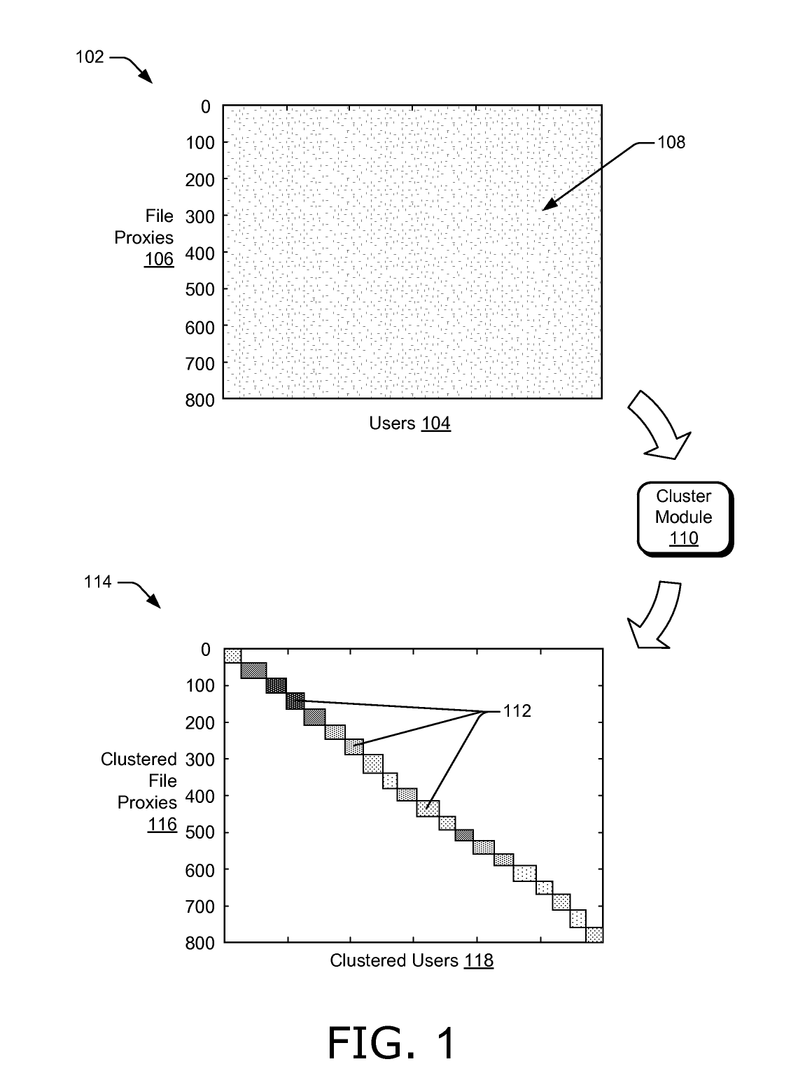

FIG. 1 illustrates an example input diagram 102 charting users 104 and file proxies 106. The input diagram 102 is a visual representation of an input used by the techniques to cluster files and users. The users 104 and the file proxies 106 are arbitrarily arranged in the input diagram 102, with each file accessed being abstracted into the file proxies 106. Thus, the file proxies 106 can be folders or ancestor folders in which the accessed files are stored, and act to normalize the X and Y axes but are not required. The 800 listed proxies for the input diagram 102, for example, may represent hundreds of thousands or even millions of files and file locations through the proxies. Note that proxies may also be used for other types of resources, though proxies are more suited to large numbers of resources, and may be used or not used for smaller numbers of resources, such as a number of milling machines or desktop computers.

The users 104 and the file proxies 106 are also arranged arbitrarily in the input diagram 102, therefore access of a file by a user is shown as arbitrarily-arranged (though not necessarily random) access indications 108. The access indications 108 indicate user behavior data, here that each of the users 104 has accessed a file within the file proxies 106.

Note that the users 104 may include employees or contractors of a business, personal users, whether organized or not (e.g., social groups), educational users (students, teachers, and so forth), or computing entities (e.g., software programs, service accounts, or other non-human entity having access to the repository). Any of these users can represent a security risk, whether human or computer. A computer, for example, may be running malicious code, such as code that deletes, renames, or copies files simply to damage a business or to take files hostage to gain money from the person or business affected by the loss.

These access indications 108 are received by cluster module 110. The cluster module 110 correlates the access indications 108 and the users 104 to cluster these together. Thus, it correlates subsets of the users 104 with subsets of the file proxies 106 based on the access indications 108. Each cluster correlates one of the subsets of the users 104 with one of the subsets of the files. Various of these clusters 112 (three marked for visual brevity) are shown in cluster diagram 114. The cluster diagram 114 shows clustered file proxies 116 and clustered users 118, which are rearranged from the file proxies 106 and the users 104 based on the access indications 108.

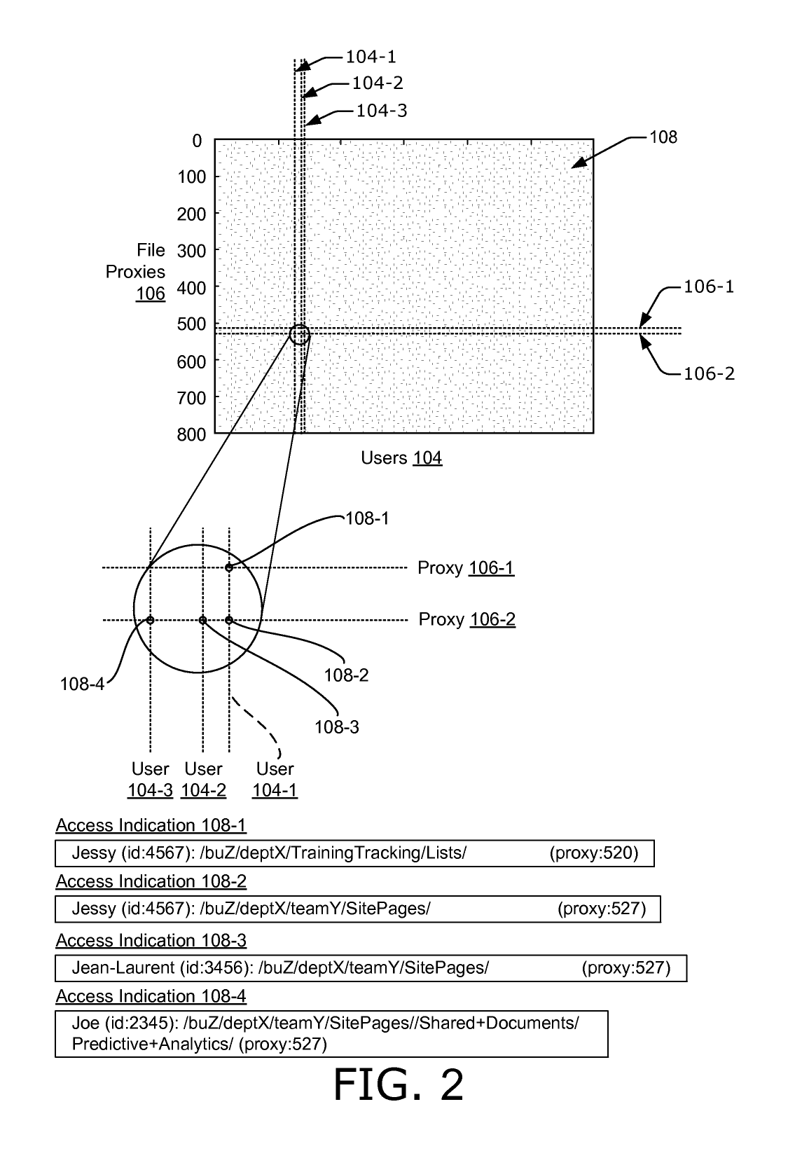

For more detail, consider FIG. 2, which illustrates four examples of the access indications 108 of the input diagram 102. Here four of the access indications 108 are shown in expanded form and marked as first indication 108-1, second indication 108-2, third indication 108-3, and fourth indication 108-4. These indications show four accesses of four files by three users (marked user 104-1, user 104-2, and user 104-3), and two file proxies 106-1 and 106-2. Three of the files are arranged into a same file proxy, the second file proxy 106-2, as shown. Thus, Jessy is the first user 104-1, Jean-Laurent is the second user 104-2, and Joe is the third user 104-3. Further, proxy 106-1 is the 520^{th} proxy in the input diagram 102, and includes the file located at:
/buZ/deptX/TrainingTracking/Lists/

Similarly, proxy 106-2 is the 527^{th} proxy of the input diagram 102, and includes two files (the SitePages file is accessed by both Jessy and Jean-Laurent), located at:
/buZ/deptX/teamY/SitePages/
/buZ/deptX/teamY/Shared+Documents/Predictive+Analytics/

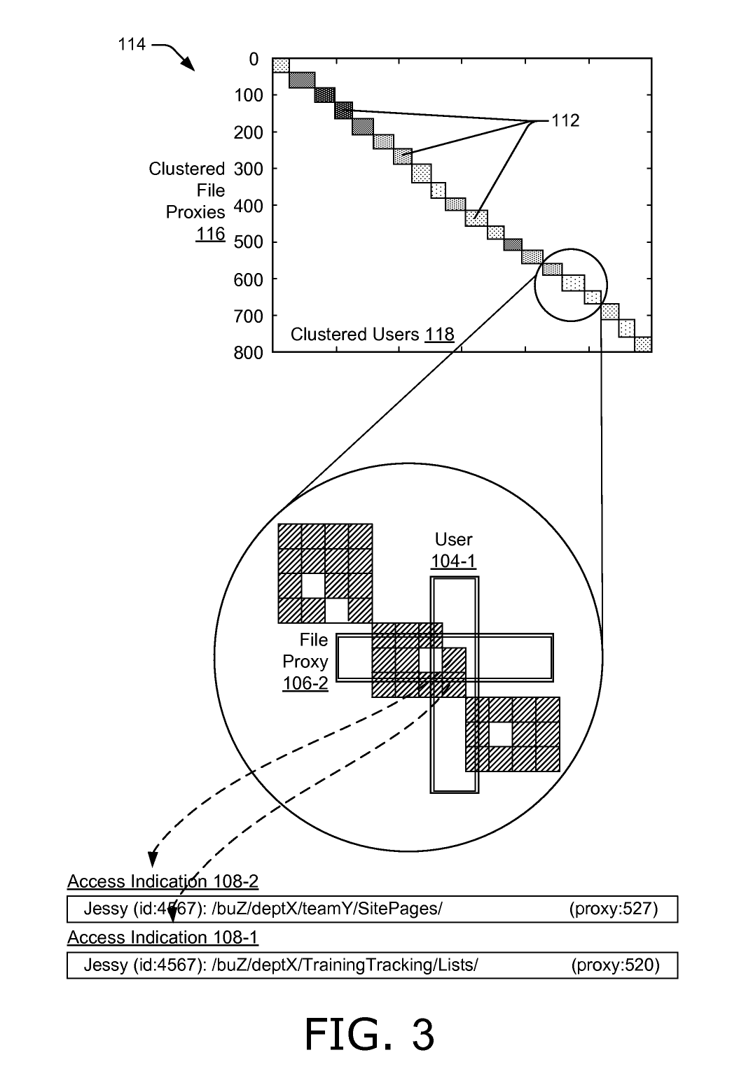

With the access indications 108, the users 104, and the file proxies 106 illustrated and explained in detail, consider the results of the clustering of the cluster module 110, shown in FIG. 3. Here each column is correlated with a clustered user of clustered users 118 and each row is a clustered file proxy of clustered file proxies 116. Note the correlation between two access indications, first access indication 108-1 and second access indication 108-2 for the same user, first user 104-1 (Jessy). Note also that the proxies, first proxy 106-1 and second proxy 106-2 are, like the users 104, rearranged to be clustered, and thus are now in reverse order. Here user 104-1 is shown with the column in the clustered users 118, as is second proxy 106-2. Thus, the users 104 and the file proxies 106 may have the same individual users and proxies as those in the clustered users 118 and clustered file proxies 116, but in different arrangements. Some users or proxies, however, may be removed and thus not shown in the clustered diagram 114 due to no or little use.

With these example access indications and clustering set forth, the discussion turns to example methods by which this clustering can be performed, as well as various cases in which clusters permit numerous other advantages. Following these methods, an example device is described by which the techniques may be performed.

### Example Methods for Clustering a Repository Based on User Behavioral Data

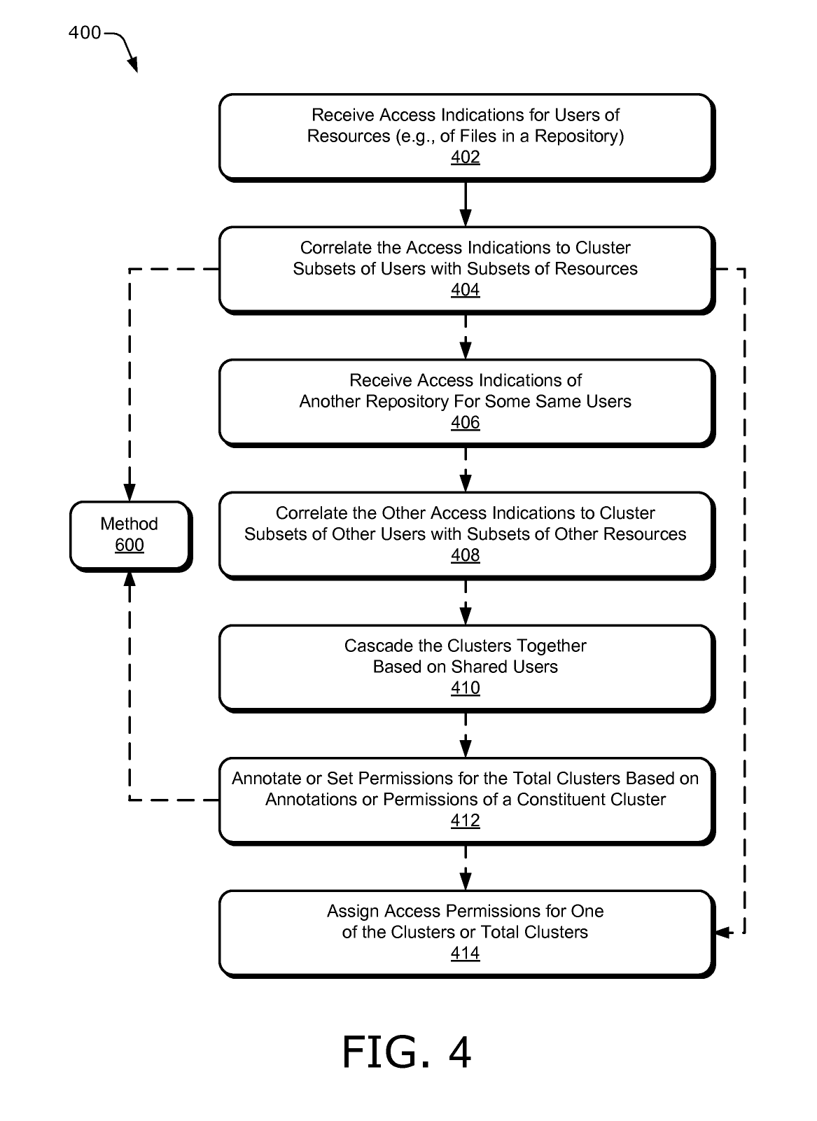

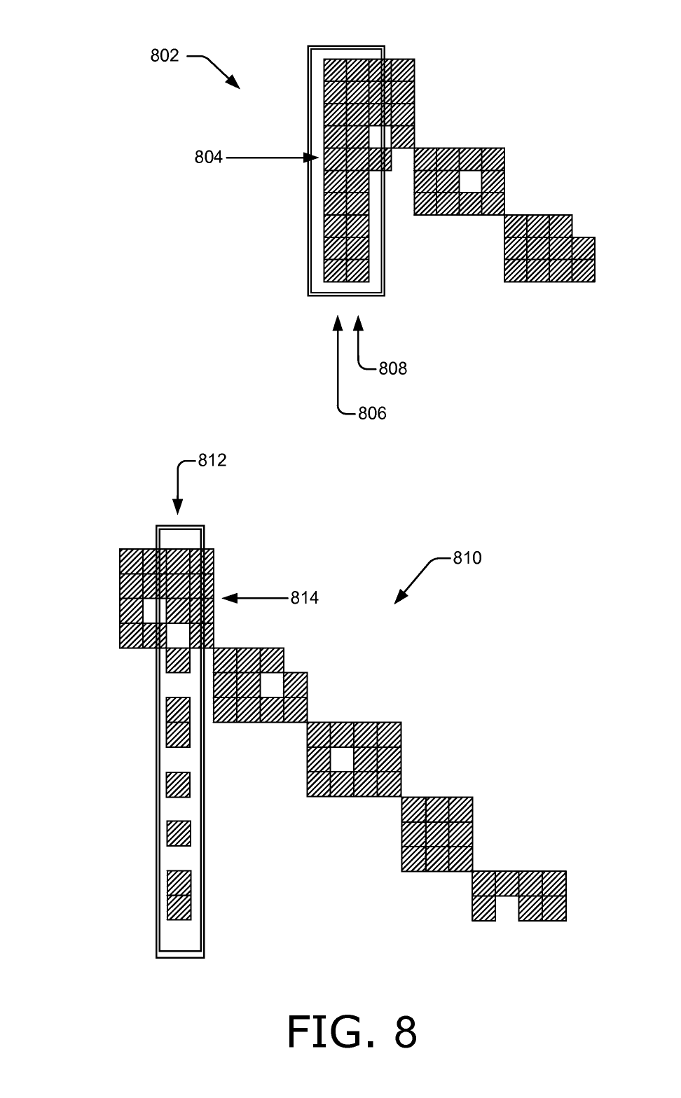

FIG. 4 illustrates a method 400 for clustering a repository based on user behavioral data. This method is shown as blocks that specify operations performed but are not necessarily limited to the order or combination. In portions of the following discussion reference may be made to FIGS. 1-3, 5, and 7-9, which are intended as non-limiting examples only.

At 402, access indications for multiple users of multiple resources are received. Each of the access indications indicate a resource, in this example a file or file location in a file repository and a user of the multiple users. An example of this is shown in FIGS. 1-3. As noted, the access indications can indicate a file name, file location, resource name or metadata, and a user.

In the case of resources more generally, and in some cases files and folders, metadata may instead or additionally be used to cluster the resources. Example metadata includes a name, type, location, and time of use, for example. Thus, access to a silicon-wafer processing machine can be recorded through the name of the machine, the type of machine (e.g., manufacturer, date of manufacture), location in a fabrication plant or in which plant, or a time of the use of the machine. Further, as noted below, this metadata can be useful in assessing risk, for example, if combined with other metadata, such as combining a machine's unique identifier with a time of access when that access is during a plant shutdown.

In more detail, the file or the file location in the repository may indicate a folder in which the file is contained or an ancestor folder of the folder in which the file is contained. In such a case, later-performed correlations are with the folder or the ancestor folder and not the exact file or file location. While described often herein as files, folders, and so forth, the techniques are not limited to folder-based repositories or even repositories at all. For example, a repository can be arranged as a list without hierarchy or can be unorganized. Thus, the file or the file locations in the repository can be indicated using a universal resource locator (URL). The proxy, while not required, in this case can be a genus indicator of which the URL is a species, such as multiple URLs having text in common. The following URLs show one such genus in bold, with the species in italics below:
https://en.wikipedia.org/wiki/Lucretia_Garfield
https://en.wikipedia.org/wiki/Lucretia_Garfield#Early_life
https://en.wikipedia.org/wiki/Lucretia_Garfield#Romance_marriage
https://en.wikipedia.org/wiki/Lucretia_Garfield#Children
https://en.wikipedia.org/wiki/Lucretia_Garfield#First_Lady_of the_United_States

For example, the genus can be one level higher than the specific full URL, such as “Lucretia_Garfield” or two levels higher, such as “wiki”. The species of these five URLs (assuming “Lucretia_Garfield” is the genus) are, in the first case, nothing, and in the next four are “Early_Life”, “Romance_marriage”, “Children”, and “First_Lady_of_the_United_States”.

At 404, the access indications and the multiple users are correlated. This correlation creates clusters, which cluster together subsets of the multiple users with subsets of the resources.

As noted, files or file locations can be arranged into file proxies, which is effective to at least partially normalize numbers of files and file locations with users (e.g., ½× to 2× file proxies/users), as numbers of files and file locations can be orders of magnitude higher than the number of users accessing those files. Thus, each cluster correlates one of the subsets of the multiple users with files indicated in one of the subsets of access indications. To perform the correlation or as part of building each cluster, each file proxy or file can by annotated with names or identifiers for each user accessing those files. With these annotations, the cluster module 110 may then arrange the file proxies and the users to visually cluster them for an administrator's benefit, to aid in his or her analysis, though this human-readable visual presentation is not required for many of the features described herein.

As noted in part above, the techniques can be used for a single or multiple repositories or other overarching systems or organization. The method may skip operations 406, 408, and 410, proceeding directly to operation 412, or proceed to operation 406 for another repository.

At 406, other access indications of another file repository are received. These access indications indicate files accessed by other users, though these access indications can be analyzed to determine at least some shared users of the other file repository as that of the first-mentioned file repository. The other file repository need not be similar in hierarchy, type, or otherwise. Thus, the first-mentioned file repository can be a hierarchical file-folder system and the other repository can be various servers accessed through URLs, for example.

At 408, the other access indications and the other users are correlated to cluster together the subsets of the other users with subsets of the other files. As in operation 404, these files or file locations can be arranged into, or analyzed through file proxies, which is illustrated above.

With the clusters determined for the two repositories, at 410, the clusters and the other clusters are cascaded together based on having some shared users between the subsets of the other users and the subsets of the multiple users. These cascaded clusters are total clusters of both repositories. This cascading can include adding or concatenating together file proxies from one repository into a cluster for another repository based on shared users. Cascading may instead simply show clusters from both repositories presented next to each other to permit an administrator to see the relationship between the two. Thus, an upper portion of a total cluster may represent a first repository's cluster for shared users, and a lower portion of the total cluster represent a second repository's cluster for the shared users. The columns, in this case, are users, and thus the shared users will show blocks for the accessed file proxies of both, which users not shared will not show blocks for file proxies of both repositories.

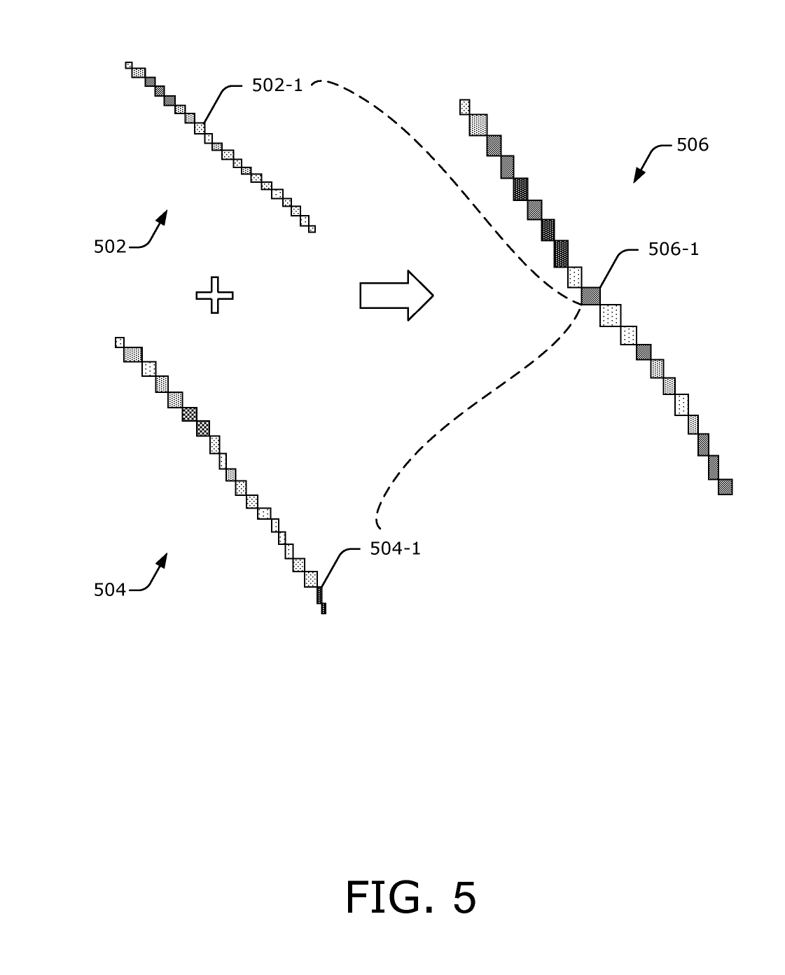

Consider, for example, FIG. 5, which illustrates first clusters 502 of a first repository, such as through performing operations 402 and 404 of method 400, and second clusters 504 of a second repository, such as through performing operations 406 and 408 of method 400. FIG. 5 illustrates total clusters 506 resulting from performing operation 410. Here the clusters of each of the repositories are correlated based on having same or similar shared users of each cluster.

This cascading of clusters enables various features and can save substantial time and effort. Consider an example where the cluster 502-1 has been annotated with a name based on the subset of users that are clustered with it, and that this subset of users is responsible for some sort of project, e.g., a project called TPS reporting. Thus, the cluster is named TPS. Assume also that there is no useful annotation for clusters of the other repository, but that one of these other clusters has numerous shared users with that of the TPS cluster, here marked other cluster 504-1. On cascading these two clusters into a total clusters at the total clusters 506, these are cascaded into total cluster 506-1. The techniques may annotate the total cluster 506-1 with the annotation of either of the constituent clusters 502-1 or 504-1, here with the name TPS from the cluster 502-1. This enables an automatic (or easily user-selected) annotation of the total group and, based on it, an annotation can as easily be made to the other cluster 504-1, such that all three of these example clusters are annotated as any one of them.

This operation is illustrated at 412 in FIG. 4, at which the techniques annotate the total cluster based on annotations of one of the constituent clusters. Similarly, if one of the constituent clusters 502 or 504 has access permissions, the techniques may automatically set access permissions of the other constituent cluster to match, or enable easy user-selection to set those access permissions to the shared users of the cluster 502-1 with those of the other cluster 504-1. As noted above, these clusters can be clusters of users and resources other than files or folders, such as a subset of employees of a business clustered with a printer and another subset clustered with another printer.

Whether a total cluster resulting from cascading clusters of repositories, or a single repository from operations 402 and 404, the techniques may assign access permissions at operation 414 for one of the clusters, such as one of clusters 112, 502, 504 or total clusters 506.

Furthermore, while the method 400 sets out a particular order of operations, this is not required. For example, the operation 404 can be skipped and instead the operation 408 performed on the cascaded array. Or, some portion of a total cluster can be used to infer another portion of the total cluster. In such a case, the operation 410 can be skipped. For another example, some operations can be combined, such as receiving access indications at operation 402 for two, three, or more repositories at one time. Or, the operations of 402 and 404 can be combined for some number of repositories and then re-perform the method for another repository. Thus, the method 400 is an example of one way in which the techniques may be performed.

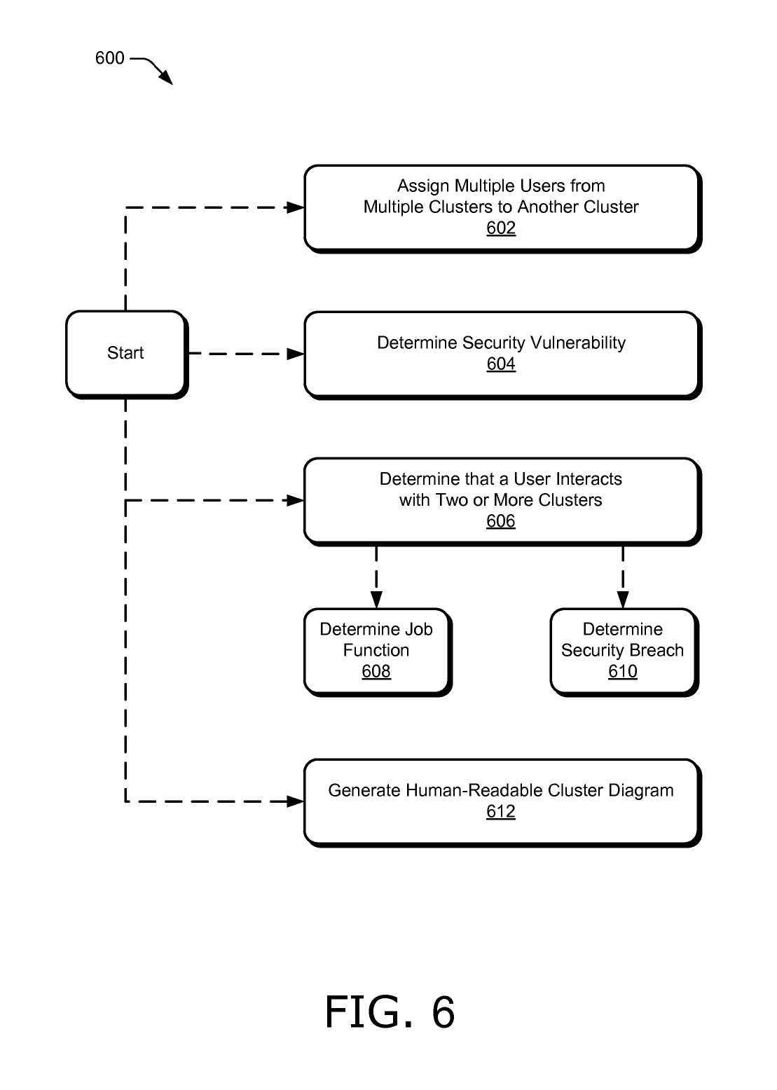

Additionally or alternatively, the techniques may use clustering to enable other features. Consider FIG. 6, for example, which illustrates method 600 in which alternative or additional operations of the techniques are shown. These operations can be performed separately or together. The following examples continue the prior example in which resources are files and folders.

As noted above, a cluster and file proxies of that cluster can be annotated (e.g., named) for the work project or otherwise assigned to a project. This aids in users understanding what files go to what project, the type and usage of the project, and for administrators to assign access permissions and so forth. As used herein, a project can be any organization shorthand, sub-organization, file similarity, goal, or arrangement. These projects can be a particular product or update being developed by an organization or a particular client's work project (e.g., marketing documents developed for a client, or attorney-client work product developed by a team of attorneys and paralegals for a particular client). These annotations can be useful for some of the features enabled through method 600.

At 602, users of multiple clusters are assigned to another cluster. This assigned-to other cluster may have users from multiple different clusters because it is an overarching work project of these clusters. Or, this assigned-to cluster may instead have applicability over multiple projects but not be an overarching project of its own, such as for templates and commonly used files having general applicability.

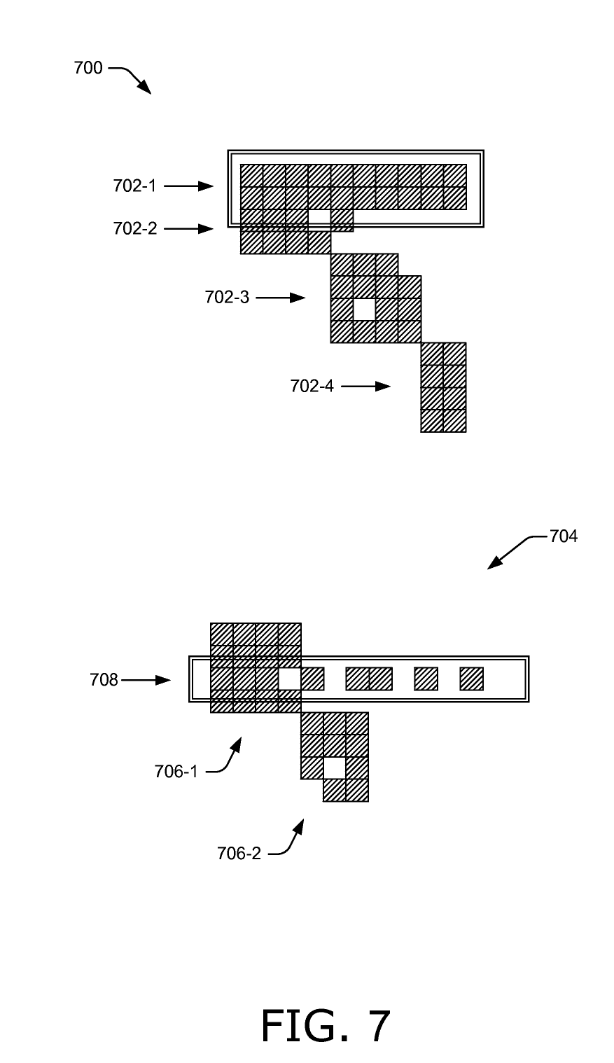

Consider, for example, cluster diagram 700, which has clusters 702 of FIG. 7. Four clusters 702-1, 702-2, 702-3, and 702-4 are shown. The cluster 702-1 has 11 users and two file proxies, as shown by the 11 columns and two rows. The cluster module 110 may select to assign the cluster 702-1 as a generally applicable group of files needing access by many users. With this information, the cluster module 110 or an administrator may select access permissions to the users clustered with the three remaining clusters, 702-2, 702-3, and 702-4, as these users are shown to access files within cluster 702-1.

Consider, for example, a case where some files are used by many users, some as a form template, commonly used boilerplate, or design or manufacturing element having specifications in this location. These are clustered into a cluster having many users, even from users having disparate clusters themselves. This information can be useful in assigning protections broadly, but in other ways as well, as it indicates importance. If one of these files is being widely used across the business, it may be worth the effort to regularly update and improve the file, as it benefits and harmonizes many projects. This is but one advantage of clusters having users from multiple other clusters.

At 604, a security vulnerability in the repository is determined based on one or more of the files being accessed by users not clustered with those files. The cluster module 110 determines, based on a file proxy having many users across many clusters accessing it, that the file or files in the file proxy are either widely used due to importance or applicability or that the access permissions for that file proxy may need be improved (assuming the repository currently has access controls). One such example is show in FIG. 7, which illustrates cluster diagram 704 having clusters 706, showing one row (and thus one file proxy, marked file proxy 708) but access by many users of different clusters (two clusters shown at cluster 706-1 and 706-2, others not shown). Note that the users of clusters 702 are likely not a security risk, while those of cluster 708 are, as noted in more detail below.

At 606, it is determined, based on two or more of the clusters, that a particular user interacts with two or more clusters. Based on this determination, the cluster module 110 may determine, at operation 608, a job function of the user, or a security breach at operation 610.

This interaction with multiple clusters enables determining a job function of that user based on that user's behavior, as it indicates interaction with projects correlated with each of those clusters. This may indicate that the user is a manager of these clusters, an example of which is shown with cluster diagram 802. The cluster diagram 802 includes a cluster 804 having two columns, and thus two users 806 and 808, interacting with three clusters (but not more than three clusters). The number of clusters to which a user may access is determinable based on the job function of the user or vice versa, and may vary, from a small number of clusters to dozens. Some general rule can be set forth, such as a limit on a number of clusters before a security alert is triggered, or it can be based on other data, such as an administrator studying each case. Once the user's access is determined to be legitimate, the job function based on that access are then determined, either by human interaction or automatically by the techniques. Assuming that there are more than three other clusters, this cluster 804 indicates that each of these two users is a manager or perhaps an assistant helping many users of those three clusters (or a security risk if their legitimacy has not been established). This is not limited to a manager or assistant, other likely legitimate persons include a system architect, quality assurance personnel, or administrator, to name a few.

In contrast, consider cluster diagram 810, which shows one user 812 having interactions with five clusters. Note that the interactions are sporadic with four of the clusters. Based on these interactions, the cluster module 110 may indicate that these interactions by the user outside his or her cluster (cluster 814) should be investigated as a potential security breach.

In both cases the cluster module 110 may determine a user's job function or a potential security risk, though this determination can be aided by determining the type of access of those files or based on other information, whether internal to or external to the repository. Thus, the cluster module 110 may determine that a user is legitimate based on external information, like a title of the user or a department of the user. Or based on internal information, such as the type of file, the extension of the file, the type of access as noted, or a date, time, place, server, or terminal of the access. A user that is not in the security department and is not a manager that accesses files from many clusters after 2 am and then copies the files over to an external drive, would very likely be flagged by the cluster module 110 as a security risk.

Thus, the cluster module 110 determines, for the cluster diagram 802, the type of access of the users 806 and 808. The cluster module 110 also determines, for the user 812 of the cluster diagram 810, the type of access. Assume that the cluster module 110 determines that the user 806's accesses are opening, viewing, and approving most files (e.g., through workflow approval or signature). Based on this, the cluster module 110 determines that the user 806 is a manager. Similarly, assume that the cluster module 110 determines that the user 808's accesses are mostly printing. Based on this, the cluster module 110 determines that the user 808 is an administrative assistant. Conversely, assume that the cluster module 110 determines that the access by the user 812 for access outside of the cluster 814, is often copy, print, and view, but rarely merge, resave, or alter. Based on this, the cluster module 110 may pass this information to an administrator for review, or may set access permissions to prohibit access outside of the cluster 814 (or all clusters) for the user 812.

At 612, a human-readable cluster diagram is generated. Examples of these or portions thereof are illustrated in FIGS. 1, 3, 5, 7, and 8. By normalizing files via file proxies with users, and by arranging the clusters to be human-readable, here through a visual interface having rectangles for each cluster, an administrator may more-easily evaluate clusters, security issues, job functions, and so forth. Thus, in some cases a human being can review this cluster diagram and make decisions based on it, such as that a user is a potential security risk, that some files are vulnerable, a user's job functions, annotations to clusters or total clusters, and so forth.

For example, an administrator may select a cluster presented in an interface showing the human-readable cluster diagram and annotate that cluster or select access permissions for that cluster. Further, particular users or file proxies can be annotated or permissions set, such as a user that may be a security breach. On selection, the cluster module 110 may pass an instruction or otherwise cause the files or users to have access permissions altered or annotations added.

In addition, the cluster module 110 may label various clusters, users, and files or file proxies based on determinations made as part of methods 400 and 600, such as to label security vulnerabilities, security breaches, job functions, access permissions, and annotations. This labeling can aid a human user of the cluster diagram to better interact with, or act responsive to, the cluster diagram.

### Example Electronic Device

With example methods for clustering a repository based on user behavioral data set forth, as well as example clusters and their use, the discussion turns to an example electronic device in which techniques for clustering a repository based on user behavioral data can be implemented.

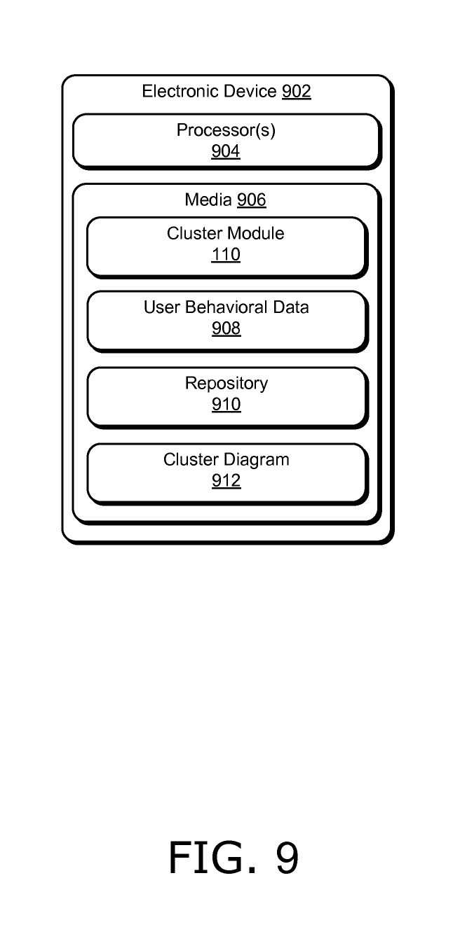

FIG. 9 illustrates an electronic device 902 having one or more computer processors 904 and computer-readable storage media (“media”) 906. The media 906 includes or has access to the cluster module 110, user behavioral data 908, and repository 910. The cluster module 110, as noted above, is configured to cluster the repository 910 (or additional repositories) based on the user behavioral data 908. This clustering can result in a machine-readable and/or human readable clustering, such as a cluster diagram 912. Examples of this cluster diagram 912 are illustrated and described above, such as at cluster diagrams 114, 700, 704, 802, and 810, and clusters 502 and 504 and total clusters 506.

Examples of the user behavior data 908 includes access indications, such as those from a repository log data file or other recording of user interactions with files or folders in a repository. Thus, a repository log data file may include a user name, employee ID, or identifier of a computing device correlated with the user where that computing device is the device accessing the file. The repository log data file may indicate a file being access, or version thereof, a folder having the file, or an ancestor folder having the file, or a time of access (e.g., a timestamp) for example. This repository log data file may indicate both users and files accessed within a single or multiple logs. If multiple logs, correlating each may be performed such that user access and files accessed are correlated. The repository log data file, or other data indicating users and files accessed, may indicate a type of access as well, such as an open, print, view, edit, merge, save, delete, or move action.

The electronic device 902 may be a mobile or battery-powered device or a fixed device that is designed to be powered by an electrical grid during operation. Examples include a server computer, a network switch or router, a blade of a data center, a personal computer, a desktop computer, a notebook computer, a tablet computer, or a smart phone. The processors 904 can be single or multi-core processors. The media 906 may include one or more memory devices that enable persistent and/or non-transitory data storage (i.e., in contrast to mere signal transmission), examples of which include random access memory (RAM), nonvolatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. A method for clustering resources and multiple users, the method comprising:
receiving access indications for the multiple users, each of the access indications indicating a resource and a user of the multiple users; and
correlating the resources and the multiple users to cluster together subsets of the multiple users with subsets of the resources indicated in the access indications, each cluster correlating one of the subsets of the multiple users with one of the subsets of the resources.

2. The method of claim 1, wherein the resources are files or file locations in a repository and the correlating clusters together the subsets of the multiple users with the subsets of the files or the file locations as file proxies of the files or the file locations, the file proxies effective to normalize a number of the files or file locations with a number of the multiple users.

3. The method of claim 1, wherein the resources are files or file locations in a repository and further comprising:
receiving second access indications of a second file repository for other users having at least some shared users with the multiple users of the file repository, each of the second access indications indicating a second file or second file location in the second depository and a user of the other users;
correlating the second access indications and the other users to cluster together the subsets of the other users with subsets of the files or file locations indicated in the second access indications, each of the second clusters correlating one of the subsets of the other users with one of the subsets of the files or file locations in the second access indications; and
cascading together the clusters and the second clusters based on having shared users between the subsets of the other users and the subsets of the multiple users effective to provide total clusters.

4. The method of claim 3, wherein the cluster or the second cluster includes an annotation indicating a name, project, or group for the cluster or the second cluster and further comprising annotating the total cluster with the annotation of the cluster or the second cluster.

5. The method of claim 3, wherein the cluster or the second cluster includes access permissions and further comprising automatically setting permissions of the other of the cluster of the second cluster to the access permissions.

6. The method of claim 1, wherein the resources are files or file locations in a repository and each of the files or the file locations indicated in the access indications indicates a folder in which the file is contained or an ancestor folder of the folder in which the file is contained and wherein the correlating correlates based on the folders or the ancestor folders.

7. The method of claim 1, wherein the resources are files or file locations in a repository and each of the files or the file locations indicated in the access indications indicates a universal resource locator (URL) and wherein the correlating correlates based on an genus indicator of which the URL is a species.

8. The method of claim 1, further comprising generating a cluster diagram visually presenting the clusters.

9. The method of claim 1, wherein the resources are files or file locations in a repository and the access indications are a repository log data file recording user interactions with folders in the repository.

10. The method of claim 1, further comprising determining that a particular user interacts with two or more of the clusters.

11. The method of claim 10, further comprising assessing that the particular user is a manager, system architect, quality assurance personnel, or administrator of the two or more of the clusters.

12. The method of claim 10, further comprising determining that the particular user is a security risk due to the particular user interacting with the two or more of the clusters.

13. The method of claim 1, further comprising automatically setting access permissions for one of the clusters, the access permissions assigned to the subset of the multiple users of one of the clusters.

14. The method of claim 1, wherein the resources are files or file locations in a repository and the repository includes access permissions and further comprising determining a security vulnerability in the repository based on one or more of the files being accessed by users not clustered with those files.

15. The method of claim 1, wherein the access indications indicate a type of access, the type of access being an open, print, view, edit, merge, save, delete, or move action.

16. The method of claim 1, wherein the multiple users are human employees, human contractors, or computing entities.

17. An electronic device comprising:
one or more computer processors; and
one or more computer-readable media including:
user behavioral data, the user behavioral data indicating user access of files of a repository by multiple users; and
a cluster module, the cluster module configured, when executed by the one or more computer processors, to correlate the user access of files of the repository by the multiple users into clusters, the clusters clustering subsets of the multiple users with subsets of the files indicated in the user behavioral data.

18. The electronic device of claim 17, wherein the cluster module is further configured to automatically set access permissions for the multiple users based on the clusters in which each of the multiple users is clustered.

19. The electronic device of claim 17, wherein the cluster module is further configured to automatically annotate:
the files of a cluster with information correlated with the users of the cluster;
the users of the cluster with information correlated with the files of the cluster; or
the cluster with the information correlated with the users of the cluster or the information correlated with the files of the cluster.

20. The electronic device of claim 17, wherein the one or more computer-readable media further includes the repository.

21. One or more computer-readable storage media having instructions stored thereon that, responsive to execution by one or more computer processors, performs operations comprising:
receiving access indications for users of a file repository, each of the access indications indicating a file or file location in the file repository and a user of the users;
normalizing numbers of the files or file locations to numbers of the users through use of file proxies;
correlating the file proxies and the users effective to cluster together subsets of the users with subsets of the file proxies, each cluster correlating one of the subsets of the users with one of the subsets of the file proxies; and
generating a human-readable cluster diagram presenting the clusters.

22. The media of claim 0, wherein the human-readable cluster diagram enables human interaction, and further comprising: receiving an annotation to the human-readable cluster diagram; and applying the annotation to a selected one of the clusters.

23. The media of claim 0, wherein the human-readable cluster diagram enables human interaction, and further comprising: receiving an access permission and selection of a file, file proxy, or user; and causing the access permission for the selected file, file proxy, or user to be altered.

24. The media of claim 0, further comprising:
receiving second access indications for second users of a second file repository, each of the second access indications indicating a second file or file location in the second file repository and a second user of the second users;
normalizing numbers of the second files or file locations to numbers of the second users through use of second file proxies;
correlating the second file proxies and the second users effective to cluster together subsets of the second users with subsets of the second file proxies, each second cluster correlating one of the subsets of the second users with one of the subsets of the second file proxies;
cascading together the clusters and the second clusters based on having shared users between the subsets of the second users and the subsets of the users effective to provide total clusters; and
generating another human-readable cluster diagram, the other human-readable cluster diagram presenting the total clusters.

25. The media of claim 0, further comprising determining a security breach by a user of the users, and labeling the user to indicate the security breach.

26. The media of claim 0, further comprising determining a security vulnerability of one of the file proxies and labeling the determined one of the file proxies to indicate the security vulnerability.

27. An electronic device comprising:
one or more processors; and
one or more computer-readable storage media including:
user behavioral data, the user behavioral data indicating user access of files of a repository by multiple users; and
means for correlating, based on the user behavioral data, the files of the repository with the multiple users effective to cluster subsets of the multiple users with subsets of the files.

28. The device of claim 27, wherein the means for correlating is further configured to automatically set access permissions responsive to the correlating and based on the clusters.

29. The device of claim 27, wherein the means for correlating is further configured to automatically annotate one of the clusters based on information about users of the one of the clusters or files of the one of the clusters.

30. The device of claim 27, wherein the means for correlating is further configured to present the clusters in a cluster diagram that enables selection of access permissions or annotations for each of the clusters.
